(19) United States
(12) Patent Application Publication
(10) Pub. No.: US 2009/0250542 A1
(43) Pub. Date: Oct. 8, 2009

(54) Pre-wound Open Face Spinning Reel Spool Replacement Apparatus

(76) Inventor: David Alvin Kirkpatrick, Klamath Falls, OR (US)

Correspondence Address: BERENATO, WHITE & STAVISH, LLC, 6550 ROCK SPRING DRIVE, SUITE 240, BETHESDA, MD, 20817, US

(21) Appl. No.: 12/271,531

(22) Filed: Nov. 14, 2008

Related U.S. Application Data
(60) Provisional application No. 61/041,721, filed on Apr. 2, 2008.

(51) Int. Cl. A01K 97/00; A01K 89/00

(52) U.S. Cl. 242/322

(57) ABSTRACT

A two or three part pre-wound replacement spool system for an open face fishing reel is disclosed. The system includes four parts: a mounting spool that fits onto the arbor of the reel; a complementary disposable line holding spool made of biodegradable materials which slides onto the mounting spool; a retainer cap, connecting to the mounting spool and reel arbor, to hold the line holding spool in place; and, a quantity of fishing line which has been pre-wound onto the line holding spool. One version of the system includes a heavier end flange on the pre-wound replacement spool, thusly eliminating the need for an additional retainer cap.

This application claims the benefit of U.S. Provisional Ser. No. 61/041,721, filed Apr. 2, 2008.

### BACKGROUND OF THE INVENTION

1. Field of the Invention

The invention relates generally to a replaceable, disposable, biodegradable, pre-wound line spool for any open face spinning reel. Specifically, the invention relates to a collaborating reel post mounting spool in combination with a detachable, replaceable pre-wound replacement fishing line spool.

2. Background

Presently manufactured spinning reels allow for convenient change of line holding spools, but the spools are the same spools as come with the spinning reel and are, accordingly, made of durable materials. Since they are not disposable and are made to be a complete replacement of the original line holding spool, they are more expensive and can potentially vary manufacturer to manufacturer. In addition, because the dimensions of the line spools are fixed, the amount of line on the spool decreases as the test weight of the line increases. In general use, this is the opposite of what you want. Bigger fish demand more line.

My spinning reel of the present invention replaces the original manufacturers' line holding spool with a modified mounting spool which then receives the less expensive disposable line holding spools.

The present invention eliminates the need to manually wind line onto the line holding spool of a spinning reel and provides convenient and economical spare spools of line for the fisherman.

### SUMMARY OF THE INVENTION

The present invention advantageously fills the aforementioned deficiencies by providing a pre-wound disposable, biodegradable line spool for any open face spinning reel that eliminates the need to manually wind line onto the line holding spool of a spinning reel and provides convenient and economical spare spools of line for the fisherman.

The four components of the present invention are described as follows:

The mounting spool is made of a durable material and is designed to slip onto the arbor of an existing spinning reel. The cylindrical portion of the original equipment (OE) spool is modified to be a post of a non-cylindrical shape, for instance any shape with edges, i.e., hexagon or square shape or splined. The upper flange of the OE spool is eliminated and the upper end of the post is enclosed but with an opening for the arbor of the spinning reel. The post is the same length as the disposable line holding spool. The diameter of the base of the mounting spool is slightly larger than that of the disposable line holding spool to allow for a slightly raised lip around the outer edge to prevent snagging as the line is retrieved.

The pre-wound disposable biodegradable line holding spool has a cylindrical core with a flange at each end. The center of the cylindrical core is shaped and configured in such a manner that the contours of the hollow center match the contours of the mounting spool post. The core volume between the cylindrical wall and the wall of the hollow center is filled with a biodegradable material such as paper pulp or degradable plastic foam.

The retainer cap is a disc of the same diameter as the base of the mounting spool. It has a slight lip around the outer edge which fits over the disposable line spool, holds it in place and prevents snagging on retrieval of the line. The retainer cap is made of durable material.

When assembled and placed on the arbor of the OE spinning reel, the outer dimensions of the components of the invention will match those of the OE line holding spool and the components will be held in place by the OE drag control knob (not pictured) in the same manner as the OE line holding spool.

The line wound onto the disposable line spool is standard fishing line. However, the first few yards wound onto the spool are marked with intermittent bands of dye as a signal to the fisherman that his line is running out.

The disposable line spool can be made with a thicker top flange which would eliminate the need for the retainer cap. The dimension of the cylinder of the disposable line spool can be changed according to the test weight of the line, a larger cylinder for light test weight, a smaller dimension for heavier test weight.

Finally, it is an object of the present invention to provide a disposable, biodegradable line spool for any open face spinning reel that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a perspective view of a mounting spool in accord with the present invention.

FIG. 2 shows a pre-wound line spool according to the present invention.

FIG. 3 shows a retainer cap used in combination with the spools shown in FIGS. 1 and 2.

FIG. 4 shows a cross section of FIG. 1 along section 4-4.

FIG. 5 shows a cross section of FIG. 2 along section 5-5.

FIG. 6 shows a cross section of FIG. 3 along section 6-6.

FIG. 7 shows a partial sectional view (along 7-7) of a replacement spool system in accord with the present invention.

FIG. 8 shows a full sectional view (along 8-8) of an assembled replacement spool system in accord with the present invention.

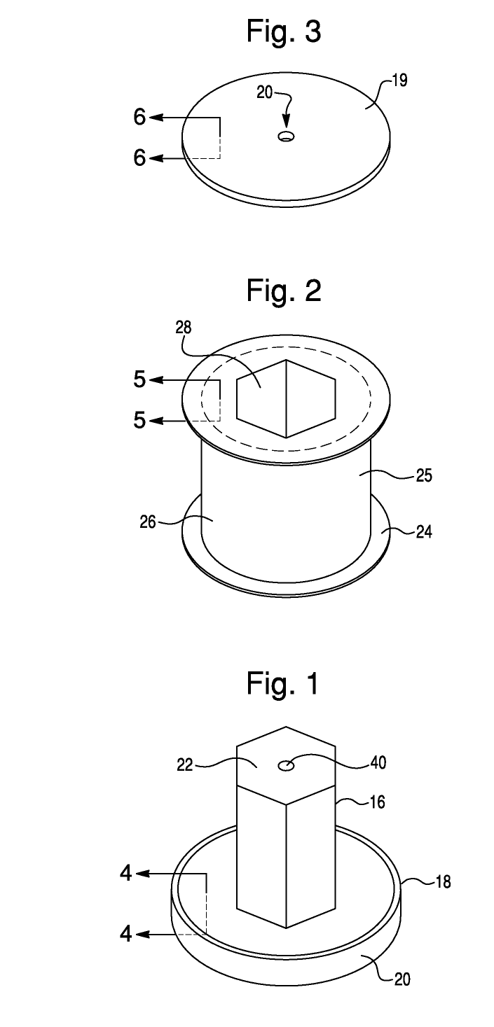

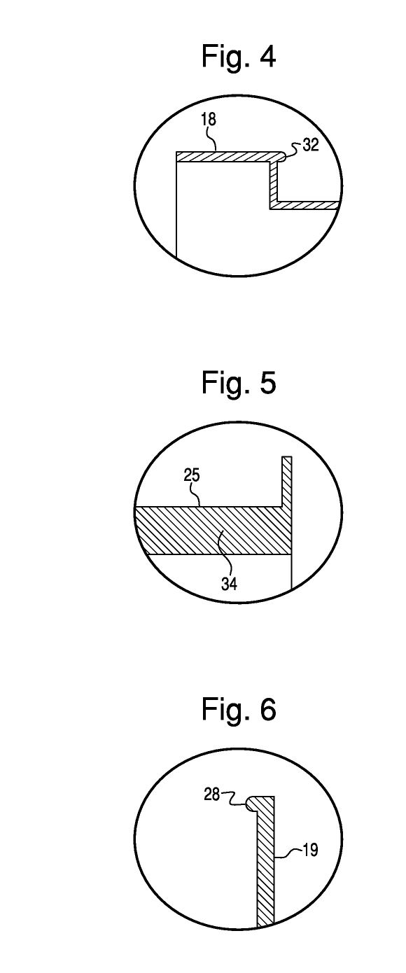

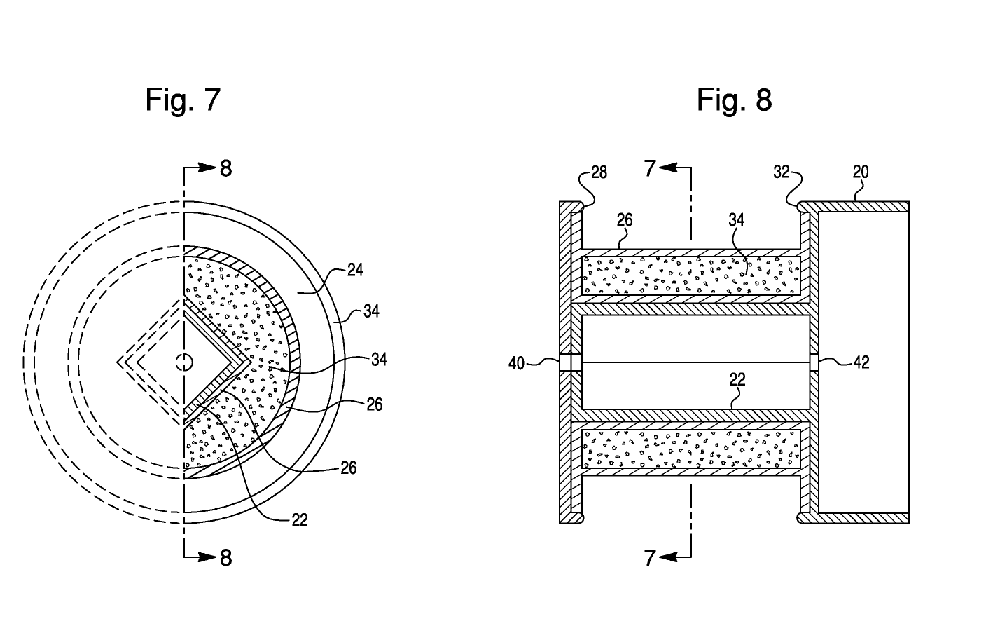

### DETAILED DESCRIPTION OF THE INVENTION

The present invention is directed to a pre-wound disposable, biodegradable line spool system for any open face spinning reel.

With reference to the drawing Figures: The present invention provides a modified mounting spool 18 to replace the Original Equipment (OE) line spool of any open face spinning reel. The said mounting spool 18 is modified by eliminating (through machining, carving, or casting) the original cylindrical center portion and upper flange of the OE line spool. These features are replaced with a post 16 of a non-cylindrical shape such as a hexagon or square (or splined) which is of the same height as the OE central core. The post 16 is capped at the end with holes 40, 42 provided for the arbor (not shown) of the reel. Around the outer edge of the base flange 20 of the mounting spool is a slightly raised edge 32 providing a recess into which fits the pre-wound disposable biodegradable line holding spool 26.

The disposable line spool 26 is of the same height as the post on the mounting spool 18. The disposable line holding spool 26 has a cylindrical core with a flange 24 at each end. The center of the cylindrical core 28 is hollow and shaped to match the contours and dimensions of the post 16 of the mounting spool 18 so it may be easily slipped on or off the post 16. The flanges 24 of the disposable line spool are slightly smaller in diameter than the base of the mounting spool 20 so that it may fit into the recess provided by the raised lip 32 in the base of the mounting spool. The disposable line spool 26 is made of a biodegradable material 34 (wood, cellulous, paper pulp, etc.) covered with a biodegradable waterproof layer or coating (paraffin, wax, etc.). The disposable line holding spool 26 can be made with a heavy upper flange (not shown) which would cover the end of the post of the mounting spool and provide a surface for the drag control knob (a standard feature on presently manufactured spinning reels) to press against. A less expensive embodiment makes the upper flange thinner and less rigid thus requiring the use of the retainer cap 19. The dimension of the cylinder 25 of the line holding spool 26 is increased or diminished to allow an equal amount of line on the spool regardless of test weight, i.e. a ten pound test line takes more room than a four pound test line and would require a smaller cylinder.

The retainer cap 19, made of a durable material, fits over the disposable line holding spool and holds it in place. It provides a surface for the drag control knob to press against. It is of the same circumference as the base 20 of the mounting spool 18 with a similar raised lip 38 around the outer edge which fits down over the edge of the line holding spool and prevents snagging during line retrieval. The retainer cap 19 has an appropriately sized hole in the center for the arbor of the spinning reel to go through in order to receive the drag control knob (not shown). The respective spools 18 and 26 are sized so that the arbor post and drag control features of the open faced reel function as they do for an OE spool.

The line wound onto the disposable line holding spool is standard fishing line with one added feature. The first few yards wound onto the disposable line holding spool are marked with intermittent bands of colored dye to warn the fisherman that he is about to run out of line.

In view of the foregoing invention configuration, the present invention advantageously eliminates the need for the sport fisherman to manually wind line onto his spinning reel. In addition, spent spools can be discarded as used and rapidly replaced with simple steps. A fisherman can go up or down in line strength as desired by selecting an appropriate replacement pre-wound spool. Inasmuch as all pre-wound replacements would fit the identical mounting spool configuration on any brand of open faced spinning reel so equipped, the necessary extra gear usually required is reduced and simplified for a fishing expedition.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A line spool replacement system for an arbor equipped open face spinning reel, comprising:
a mounting spool having a first hollow core and an axial passageway through said first core, for mounting said mounting spool onto an open face reel arbor post, and an annular base flange axially aligned with and mounted at a bottom end of said first core, an exterior surface of said first hollow core being non-circular;
a pre-wound line spool, made of biodegradable material and coated with a waterproofing agent, including a second hollow core and an axial passageway through said second core, an interior surface of said second core being non-circular and matching said exterior surface of said first core of said mounting spool so that said line spool second core interior surface is adapted to fit onto said first core exterior surface in complementary fashion, said line spool including both top and bottom flanges for containing pre-wound fishing line thereon; and, wherein
each of said respective spools is sized so that said open faced reel arbor post extends completely through the length of said respective cores when said pre-wound line spool is mounted on said mounting spool.

2. A line spool system as in claim 1, further including:
a retainer cap mounted onto said top flange of said line spool and retaining said line spool and said mounting spool onto said spinning reel arbor post, said retainer cap including a central opening so as to allow said arbor post to pass therethrough and a surrounding downwardly projecting raised lip having an inner diameter thereof matching an exterior diameter of said top flange of said line spool.

3. A line spool system as in claim 1, wherein:
said pre-wound fishing line includes a series of colored bands striped along a first few yards thereof to indicate that said line is almost run through and that a further replacement spool may be necessary.

4. A line spool system as in claim 1, wherein:
said annular base flange of said mounting spool includes a surrounding upwardly projecting raised lip, which inner diameter thereof matches an exterior dimension of said bottom flange of said line spool.
